(19) United States
(12) Patent Application Publication
(10) Pub. No.: US 2026/0027788 A1
(43) Pub. Date: Jan. 29, 2026

(54) SYSTEMS AND METHODS OF IN-SITU CONSOLIDATION OF AFP THERMOPLASTIC COMPOSITES

(71) Applicant: Wichita State University, Wichita, KS (US)

(72) Inventors: Waruna Seneviratne, Wichita, KS (US); Joshua Goertz, Wichita, KS (US); Ethan McDaniel, Wichita, KS (US); Isaac Schmitz, Wichita, KS (US)

(21) Appl. No.: 19/281,164

(22) Filed: Jul. 25, 2025

Related U.S. Application Data
(60) Provisional application No. 63/675,659, filed on Jul. 25, 2024.

(51) Int. Cl. B29C 70/38; B29C 35/02; B29C 70/54

(52) U.S. Cl. CPC B29C 70/382; B29C 35/02; B29C 70/544

(57) ABSTRACT

A system and method for in-situ consolidation and secondary heating of automated fiber placement (AFP) thermoplastic composites is disclosed. The system employs a dual-stage process wherein thermoplastic composite material is first deposited onto a mold using an AFP machine with a first compaction tool and first heater optimized for layup operations, followed by a separate consolidation pass using a second compaction tool and second heater specifically configured for consolidation. During the consolidation pass, the mold is heated above the glass transition temperature (Tg) of the thermoplastic composite material to enhance consolidation effectiveness. The system allows independent optimization of both the deposition and consolidation phases, with the capability to utilize different AFP heads for each operation or the same head with optimized parameters.

### CROSS-REFERENCE TO RELATED APPLICATION

This application claims priority to U.S. Provisional Patent Application No. 63/675,659, filed Jul. 25, 2024, which is hereby incorporated by reference in its entirety.

### STATEMENT REGARDING FEDERALLY SPONSORED RESEARCH OR DEVELOPMENT

This invention was made with government support under FA8650-19-C-5212 awarded by the Air Force Research Laboratory (AFRL) Modeling for Affordable Sustainable Composites (MASC).

### FIELD

The present disclosure pertains to an in-situ method of consolidation of thermoplastic composites using Automated Fiber Placement (AFP) to enhance composite quality.

### BACKGROUND

Fiber-reinforced thermoplastic composites have gained attention in various industries, including aerospace, automotive, and renewable energy, due to their excellent mechanical properties, recyclability, and potential for rapid manufacturing. Automated Fiber Placement (AFP) has emerged as a promising technology for fabricating complex composite structures with high precision and repeatability. Traditional methods of thermoplastic composite manufacturing often involve separate layup and consolidation steps, which can be time-consuming and energy intensive. These methods typically require post-processing in autoclaves or ovens to achieve full consolidation, leading to increased production costs.

In-situ consolidation during the AFP process has been explored as a potential solution to overcome these limitations. This approach aims to achieve full or near-full consolidation of thermoplastic composites during the layup process itself, eliminating or reducing the need for secondary consolidation steps. However, in-situ consolidation of thermoplastic composites using AFP presents challenges. These challenges include: (1) Achieving adequate heating and cooling rates to ensure proper polymer melting and crystallization, (2) Maintaining consistent pressure distribution across the consolidation zone, (3) Balancing process parameters such as layup speed, temperature, and pressure to optimize consolidation quality, (4) Addressing issues related to void formation, residual stress, and interlaminar fusion.

Previous attempts at in-situ consolidation have shown promise but have often resulted in composites with suboptimal mechanical properties or inconsistent quality compared to autoclave consolidated parts. Additionally, many existing methods are limited in their ability to process high-performance thermoplastics with high melting temperatures. There remains a desire for improved methods for in-situ thermoplastic composite consolidation using AFP that can overcome these challenges and produce high-quality parts efficiently.

### SUMMARY

Disclosed is a system and method of constructing an Automated Fiber Placement (AFP) article, more specifically, a system and method of in-situ consolidation and secondary heating and compaction of a thermoplastic composite article. First a thermoplastic composite material is deposited onto a mold with an Automated Fiber Placement (AFP) machine while applying a layup pass with a first compaction tool and a first heater to deposit the thermoplastic composite material. Using a second compaction tool and a second heater, a consolidation pass is applied to substantially consolidate the thermoplastic composite material after it has been deposited. During the application of consolidation passes the mold is heated to a temperature above a glass transition temperature (Tg) of the thermoplastic composite material.

In an embodiment, the first compaction tool and first heater are the same as the second compaction tool and the second heater. In an alternative embodiment, the first compaction tool and heater may be selected to optimize the layup process and may be different from the second compaction tool and heater which may be selected for suitable consolidation of the thermoplastic composite article.

In an embodiment, multiple layup passes may be performed for one ply. Likewise, multiple consolidation passes may be performed for one ply of the composite article. However, while layup passes are required for every ply to construct the composite article, it may be possible to apply the consolidation passes less frequently, such as but not limited to, every other ply, every 4 plies, every 8 plies, etc. In any case, the layup and consolidation occur in one AFP cell on a single mold. In an example, a secondary compaction head is retrieved by the AFP robot to apply the secondary heating and compaction force. An AFP head designed for depositing the thermoplastic composite material is used for the layup passes, leaving deposited thermoplastic material that is not fully consolidated. A secondary AFP head which has a secondary compaction tool and a secondary heat source can be automatically coupled to the AFP robot to be used for the consolidation passes. Throughout the building up of multiple plies of thermoplastic composite material, the AFP robot may switch between utilizing the layup AFP head and the consolidation AFP head.

In an embodiment, the system includes an AFP head configured to deposit thermoplastic composite material onto a mold, with a first compaction tool and first heater optimized for layup operations during material deposition. A second compaction tool and second heater are configured to apply consolidation passes to the deposited thermoplastic composite material after deposition, providing specialized processing capabilities distinct from the layup operations. The system further includes a heated mold configured to be heated above the glass transition temperature of the thermoplastic composite material during consolidation passes, and a controller that coordinates the operation of the first and second compaction tools and heaters to optimize the manufacturing process for both material deposition and consolidation phases.

The present disclosure also describes a novel method of constructing automated fiber placement articles that separates the deposition and consolidation processes for improved manufacturing control. The method involves performing a plurality of layup passes using an AFP head to deposit thermoplastic composite plies onto a mold with a first heater and first compaction tool optimized for material placement. Subsequently, at least one consolidation pass is performed using a consolidation head that is different from the AFP head, wherein the consolidation pass comprises heating the deposited thermoplastic composite plies with a second heater and applying pressure with a second compaction tool specifically configured for consolidation operations. The method alternates between these layup passes and consolidation passes as needed to construct a fully consolidated thermoplastic composite article, allowing for process optimization at each stage while eliminating the need for traditional autoclave processing.

The disclosed system and method can enable the production of fully consolidated thermoplastic composite parts without the need for autoclave processing, offering significant advantages in terms of energy efficiency, cost reduction, and manufacturing flexibility. Other aspects and features will be apparent hereinafter.

### DESCRIPTION OF DRAWINGS

FIG. 1 is a perspective view of an AFP cell with secondary heating and compaction capability;

FIG. 2 is a schematic of an AFP head capable of applying layup passes;

FIG. 3 is a schematic of the components of the AFP cell with secondary heating and compaction capability;

FIG. 4 is a schematic of a removable AFP layup head with material deposition capability and secondary heating and compaction capability according to an embodiment of the present disclosure;

FIG. 5 is a schematic of a consolidation AFP head used for secondary compaction and heating according to an embodiment of the present disclosure;

FIG. 6 is a thermoplastic composite article on a mold according to an embodiment of the present disclosure; and

FIG. 7 is a flow chart describing a method of in-situ consolidation of an AFP thermoplastic composite article with secondary compaction and heating.

Corresponding parts are given corresponding reference characters throughout the drawings.

### DETAILED DESCRIPTION

Disclosed herein is a system and method of in-situ consolidation and secondary heating of AFP thermoplastic composites (ICASH).

The inventors believe the ICASH system addresses key limitations of prior in-situ consolidation attempts through several innovations. First, it introduces dedicated secondary consolidation passes that are separate from the material deposition process, allowing for optimized processing parameters during each phase. Second, it employs controlled mold heating above the glass transition temperature (Tg) of the thermoplastic composite material during consolidation, which enhances polymer chain mobility and improves interlaminar fusion. The method comprises depositing a thermoplastic composite material onto a mold using an AFP machine while applying a first compaction force and first heat with a first compaction tool and a first heater. Subsequently, a second compaction force and second heat are applied to the deposited material with a second compaction tool and a second heater. This decoupling of the layup and consolidation processes allows each to be independently optimized—the layup pass for efficient material deposition and the consolidation pass for thorough through—thickness heating and void elimination. Unlike conventional approaches that attempt to achieve full consolidation during deposition, this method provides sufficient time and controlled conditions for proper polymer melting, flow, and crystallization. The controlled mold heating above the glass transition temperature (Tg) of the thermoplastic composite material during consolidation may enhance polymer chain mobility and diffusion across ply interfaces, potentially leading to improved interlaminar fusion, reduced void content, and enhanced overall mechanical properties of the final composite structure. When compared to prior art in-situ consolidation processes for AFP, initial process trials using the ICASH method resulted in a 10% increase in apparent shear strength, a 1% decrease in the final consolidated ply thickness (CPT), decreased porosity, and enhanced crystallinity of the thermoplastic composite article. The ICASH system and method can, in some cases, achieve full consolidation of thermoplastic composite parts without the use of an autoclave. By combining targeted secondary consolidation passes with controlled mold heating above the glass transition temperature, this approach enables the production of high-quality, fully consolidated parts directly from the AFP process. This out-of-autoclave consolidation capability represents a significant advancement over traditional manufacturing methods, potentially reducing energy consumption, processing time, and overall production costs.

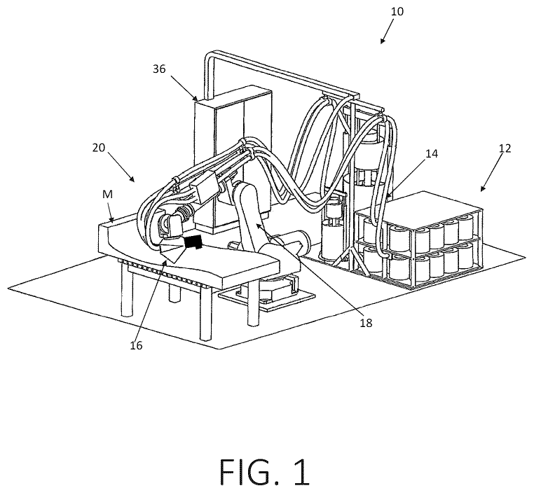

Referring to FIG. 1, an exemplary embodiment of an AFP system in accordance with the scope of the present disclosure is indicated at reference number 10. The AFP system generally comprises a fiber storage facility 12, a fiber conveyor 14, an AFP head 16, and a robot 18. Although this is one example of a type of AFP system 10, the AFP system can encompass any AFP technology that is capable of automatically applying strips of fiber in strip-by-strip fashion to a mold 50 to build a composite part. As will be explained in further detail below, the system 10 is specifically configured to support both initial layup operations and subsequent consolidation passes with the mold 50 (which supports the molding M) heated above the glass transition temperature (Tg) of the thermoplastic material. Other examples of AFP systems may incorporate the fiber storage and conveying on the head of the AFP robot 18, which can be advantageous for rapid transitions between layup and consolidation operations.

Broadly speaking, the fiber placement components of the AFP system 10 function as follows. The fiber storage facility 12 comprises one or more rolls of fiber tows that can be unwound to dispense fiber for use in an AFP process. The fiber conveyor 14 comprises flexible tubes through which fiber tows are conveyed from the fiber storage facility 12 to the AFP head 16. The AFP head 16 is mounted on the robot 18 so that the robot can move the AFP head 16 along a molding M, which includes an underlying mold 50 that typically defines a complex surface geometry for a composite part and any previously placed fiber strips. The mold 50 is equipped with heating elements that enable it to maintain temperatures above the glass transition temperature of the thermoplastic material during consolidation passes. The AFP head 16 is broadly configured for guiding the fibers from the conveyor tubes to form a strip of fibers and placing the strip of fibers on the molding M in a predefined fiber orientation. The AFP head 16 is designed to be interchangeable or reconfigurable to support both material deposition and secondary consolidation operations. As is understood by those skilled in the art, the AFP head 16 includes a large number of components, some of which are not illustrated because they are ancillary to the present disclosure. For example, the AFP head 16 suitably comprises fiber tensioners, fiber gatherers, and at least one fiber cutter that are not specifically illustrated in the drawings of this disclosure.

Referring to FIG. 1, the AFP system 10 comprises a control unit 36 (shown in a control cabinet) configured for executing preprogrammed instructions that define an AFP layup. As will be explained in further detail below, the control unit 36 incan be specially programmed with distinct parameter sets for both layup and consolidation operations, allowing for process optimization at each stage. Typically, the layup instructions will cause the AFP system 10 to form a plurality of plies on the molding M. For each ply, the control unit 36 will direct the AFP system 10 to place a plurality of strips of fiber on the molding such that the strips are arranged parallel and side-by-side in a defined fiber orientation. The deposition of the strips of thermoplastic composite material are referred to herein as a layup pass 60. A single ply of the thermoplastic composite article may be composed of multiple layup passes. The number of layup passes required depends upon the overall dimensions of the article being fabricated and the number of strips the AFP is configured to apply simultaneously.

The control unit 36 broadly comprises one or more control processors and one or more memory modules storing processor-readable control instructions configured to be executed by the control processor(s) for controlling the AFP system 10. The control unit 36 further comprises input/output (I/O) components that enable the control unit 36 to communicate with components of the AFP system 10. For example, the I/O components enable the control unit 36 to send instructions to the robot 18 that cause the robot 18 to move the AFP head 16 along a plurality of predefined fiber placement paths, to send instructions to the fiber storage facility 12 and fiber conveyor 14 that cause the storage facility and conveyor 14 to convey fiber tows to the AFP head 16 at a feed rate appropriate for the AFP process, and send instructions to the AFP head 16 that cause the AFP head to place fibers according to the AFP layup instructions. The control unit 36 also coordinates with a mold heating system (described in further detail below) to maintain appropriate temperatures during both layup and consolidation operations, with different temperature profiles programmed for each phase. The I/O components also provide feedback from the AFP process component to the control unit 36, including temperature sensors that monitor both the mold and material temperatures to ensure optimal processing conditions.

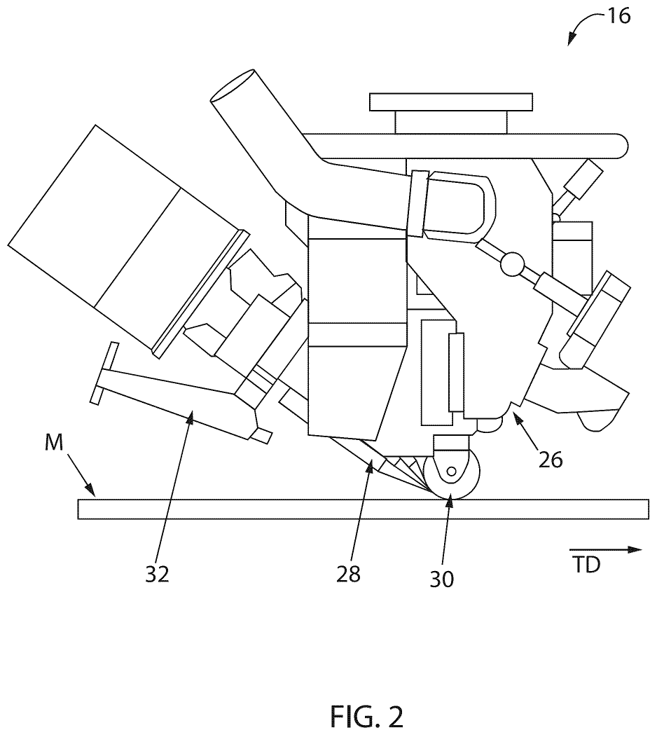

Referring to FIG. 2, the illustrated AFP head 16 comprises a chassis 26. A fiber guide 28 is operatively mounted on the chassis 26 for guiding a strip of thermoplastic composite material toward the molding M as the robot 18 moves the AFP head 16 along the molding M. A compaction roller 30 is operatively mounted on the chassis 26 such that the compaction roller 30 is spaced apart from the fiber guide 28 in a trailing direction TD for compacting the fiber strip onto the molding M. In an embodiment, the compaction roller 30 is designed to be interchangeable, allowing for different roller types to be used during layup versus consolidation operations. A heating system 32 is mounted on the chassis 26 for heating the fiber strip as it is compacted onto the molding M. The heating system 32 is positioned upstream of the compacting roller 30 in the material feed path. Its primary function is to heat the thermoplastic composite material just before it reaches the compaction point and also heat the underlying plies. This heating process softens the thermoplastic resin of the material, reducing its viscosity. As a result, when the compacting roller 30 applies pressure, the heated material adheres to the underlying surface, whether it is a previous layer of composite or the mold surface. In one or more embodiments, the heating system 32 is configured to be removable and replaceable with alternative heating systems optimized for consolidation passes, allowing for deeper, more thorough heating during the consolidation phase.

As explained above, the AFP system 10 is capable of forming composite parts with complex geometries and/or complex fiber layup patterns. To enable formation of complex and intricate composite parts, the robot 18 can comprise a multi-axis industrial robot for moving the AFP head 16 through an extensive range of motion, as shown in FIG. 1. For example, in one or more embodiments, the robot 18 comprises a six-axis industrial robot arm. The multi-axis capability is can enable the robot to follow different consolidation paths than those used during layup to optimize consolidation across the entire part. In certain embodiments, the robot 18 can comprise a seven-axis industrial robot, a gantry system, or the like. The robot 18 can also be equipped with a quick-change interface system (e.g., tool changer) that allows for rapid exchange between layup and consolidation heads, minimizing transition time between operations.

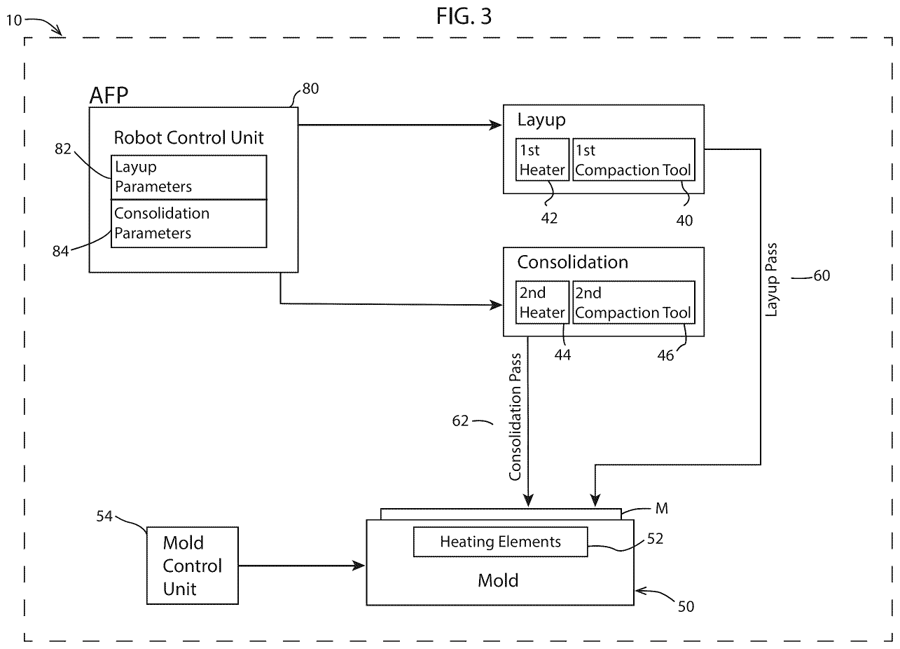

Referring to FIG. 3, a system of in-situ consolidation and secondary heating of thermoplastic composites made with AFP is shown in a simple schematic and generally indicated at reference number 10. The figure schematically illustrates two notable features of the invention: (1) the separation of the layup process from the consolidation process, and (2) the controlled heating of the mold above the glass transition temperature during consolidation. As depicted, the system includes a robot control unit 80 (which may be a component or module of the control unit 36) that manages distinct parameter sets for both layup operations (layup parameters 82) and consolidation operations (consolidation parameters 84). During a layup pass 60, the first compaction tool 40 and first heater 42 deposit thermoplastic material onto the mold 50, while during the consolidation pass 62, the second compaction tool 46 and second heater 44 apply additional heat and pressure to consolidate the previously deposited material. Simultaneously, the mold control unit 54 regulates the heating elements 52 embedded in the mold 50 to maintain the temperature above the glass transition temperature of the thermoplastic material, enhancing polymer chain mobility and improving interlaminar fusion during the consolidation phase.

During layup passes 60 and/or consolidation passes 62 (typically throughout the entire process including layup passes and secondary consolidation passes), the heating elements 52 of the mold 50 can be controlled through various methods to ensure precise temperature management. In one or more embodiments, the heating elements 52 comprise induction heating elements that use electromagnetic fields to generate heat directly within the metal of the mold 50. In certain embodiments, the heating elements 52 comprise electrical resistance heating elements in or on the mold 50. In an example embodiments, the heating elements 52 comprise fluid circulation paths within the mold 50 configured to receive heating oil that is heated by a heater external to the mold. In some embodiments, the heating elements 52 comprise infrared heating lamps at spaced apart locations from the mold to provide localized or overall heating and may be used in combination with any of the other heating techniques. Hybrid systems combining two or more of these heating elements 52 may be implemented to heat the mold 50.

The mold's temperature is monitored and regulated through a network of thermocouples or other temperature sensors strategically positioned throughout the mold 50 and within the composite article. These sensors continuously transmit temperature data to the mold control unit 54, which precisely adjusts heating parameters to maintain optimal processing conditions. The mold control unit 54 can adjust power, fluid flow, or other parameters in real-time to maintain the desired temperature profile across the surface of the mold 50 and/or within the composite article. Furthermore, the mold 50 may have zoned heating elements 52 to provide flexibility in increasing and decreasing the mold temperature in localized areas of the mold, which may be useful for composite articles with varying thicknesses.

Through experimentation, it has been found that suitable mold temperatures for in-situ consolidation processes in accordance with the present disclosure are in a temperature range from greater than Tg to less than melt temperature (Tm) of the thermoplastic matrix material. Raising the mold 50 to a temperature greater than Tg results in higher crystallinity, better interlaminar properties, and less warpage of the thermoplastic composite article. With the use of high-performance thermoplastic materials, mold temperatures in the range of 250-450° F. may be suitable. In a particular embodiment, the mold 50 may be heated to a temperature at least 40° F. greater than Tg. The temperature of the mold 50 may be monitored and controlled to impart heat into the plies that have been laid down using the AFP robot. Likewise, the temperature of the laid up thermoplastic composite material may be monitored with thermocouples or other types of temperature sensors and the mold temperature may be adjusted with the mold heating controller to adjust the mold temperature and in turn, adjust the temperature of the laid up thermoplastic composite material.

In an embodiment, each layup pass 60 is conducted using the first heater 42 and the first compaction tool 40. As thermoplastic composite material is deposited by the AFP head 16, the first compaction tool 40 and the first heater 42 apply force and heat to cause the thermoplastic composite material to soften and adhere to the mold 50 or a previously deposited ply. In an example embodiment, the first compaction tool 40 is the roller 30. In some cases, the roller 30 is an elastomeric roller, more specifically a silicone roller, and even more particularly, a 60 Shore A silicone roller. A silicone roller is used for flexibility, which can help facilitate depositing articles with complex contours. Other types of rollers that are more rigid than silicone may be used to transfer more of the compaction force from the AFP robot 18 to the thermoplastic composite material. The first compaction tool 40 may have a quick disconnect from the AFP head 16 for easy removal and installation. After a layup pass 60 is completed, the first compaction tool 40 can be removed from the AFP head 16 before conducting a consolidation pass.

In an example embodiment, the first heater 42 is a laser that is removably coupled to the AFP head 16. The laser heater 42 melts and fuses the thermoplastic material as the AFP head 16 deposits it. Suitably, the laser heater 42 is configured to emit a laser beam through one or more optics. In an example embodiment, the laser heater 42 has n (e.g., 8) optics, where each optic is configured to direct laser heating to one of the n (e.g., 8) tows deposited from the AFP head 16. In an embodiment, the laser heater 42 is configured such that 40% of the laser beam irradiates and heats the first compaction tool 40 (roller), while the remaining 60% of the laser beam irradiates and heats the previously deposited thermoplastic composite material. Thus, the laser heater 42 simultaneously heats the incoming material (tows) to be deposited and the underlying plies. This is thought to achieve better fusion of the thermoplastic composite material. Although the first heater 42 has been described as a laser heater, other types of heating sources may be used for the first heater, such as but not limited to, Hot Gas Torches (HGT) or Pulsed Light Heaters. The first heater 42 may have a quick disconnect from the AFP head 16 for easy removal and installation. After a layup pass 60 is completed, the first heater 42 can be removed from the AFP head 16 before conducting a consolidation pass.

As introduced above, the system 10 further includes the second compaction tool 46 and the second heater 44 to apply a secondary compaction force and secondary heat during a consolidation pass 62. Consolidation passes 62 are completed after at least one ply of thermoplastic composite material has been deposited through one or more layup passes 60. Multiple cycles of consolidation passes 62 may be applied to previously laid material before additional material is applied in another layup pass 60. For example, four plies may be laid down with multiple layup passes, followed by a series of consolidation passes 62. The number of consolidation passes is not fixed 62, rather, consolidation passes 62 are repeated as many times as desired to achieve complete consolidation of the thermoplastic composite article.

In an embodiment, the second compaction tool 46 is a roller. Inc certain embodiments, the second compaction tool 42 is the same roller as the first compaction tool 40. In other embodiments, the second compaction tool 46 comprises a different roller, or different type of compaction device altogether, than the first compaction tool 40. In one example, the first compaction tool 40 is an elastomeric roller and the second compaction tool 46 is a shoe compactor. Shoe compactors may be designed in a variety of shapes and sizes, they may be flat, curved, or articulated. In certain embodiments, the second compaction tool 46 comprises an inflatable bladder. In some embodiments, the second compaction tool 46 comprises an ultrasonic compactor, such as an ultrasonic horn coupled with roller compactors.

Using different compaction tools 40, 46 for material deposition and consolidation enables leveraging different compaction characteristics for each respective process phase. For layup, elastomeric rollers may provide flexibility for complex contours, while for consolidation, more rigid tools like harder (e.g., metal) rollers or shoe compactors deliver higher pressure distribution for improved interlaminar bonding and void reduction. This targeted approach may enhance processing efficiency and/or final composite quality. In the case of the layup pass, the speed and flexibility of the first compaction tool 40 are the primary driving factors for effective material deposition. For the consolidation pass 62, using a compaction tool such as a bladder or shoe can help maintain uniform pressure on the molding M while allowing the thermoplastic composite material 34 to heat soak at a slower, more controlled rate.

The operational parameters of the compaction tools can be adjusted independently for layup passes 60 and consolidation passes 62, irrespective of whether the first and second compaction tools are the same physical device or separate devices. This flexibility allows for targeted processing at each stage. For instance, during the layup pass 60, the robot control unit 80 can control the AFP system 10 to apply less force to prevent material distortion or fiber misalignment. In contrast, during a consolidation pass 62, the robot control unit 80 can control the AFP system 10 so the second compaction tool 46 (whether it's the same tool reconfigured or a different one) exerts greater force to enhance consolidation. Parameters that may be adjusted to achieve the desired level of compaction during each stage include can include force, temperature, speed, and dwell time, among others.

In some aspects, the second compaction tool 40 applies a compaction force during the consolidation pass having a compaction force in an inclusive range of from 200 N to 1500 N. This force range may provide suitable pressure for consolidation while avoiding potential damage to the composite structure or excessive deformation of the thermoplastic material.

In an embodiment, the second heater 44 is identical to the first heater 42. In another embodiment, the second heater 44 is different unit than the first heater 42. In this embodiment, before performing a consolidation pass 62, the first heater 42 may be removed from the AFP head 16 and the second heater 44 may be applied to the AFP head 16. Regardless of whether the same heater is used or different units are employed, the heating parameters can be adjusted independently for layup and consolidation passes 60, 62 to achieve the intended effects of each stage. For example, during a layup pass 60, the first heater 42 might be set to a higher output to effectively soften the incoming material for deposition. During a consolidation pass 62, the second heater 44 may be programmed to a lower output, allowing for more gradual and thorough heating of the previously laid plies of thermoplastic composite material. Lower heat output during the consolidation pass 62 can promote better inter-ply fusion, polymer chain entanglement, and void reduction without risking thermal degradation of the material.

The AFP control unit 36 may include a controller 80 that is programmed with separate sets of layup parameters 82 and consolidation parameters 84. The layup parameters 82 may include settings for material deposition such as deposition rate, compaction force, nip point temperature, tow tension, and material cutting. The consolidation parameters 84 may include different settings optimized for heating deeper into the laminate and consolidating the plies such as settings for dwell time for heat soaking and cooling the material to solidification under compaction force. The operational parameters of the compaction tools can be adjusted independently for layup passes 60 and consolidation passes 62, irrespective of whether the first and second compaction tools are the same physical device or separate devices. The controller 80 stores and executes these distinct parameter sets, automatically switching between layup parameters 82 focused on material deposition and consolidation parameters 84 focused on through-thickness heating, dwell time, and compaction force for consolidation of the laminate.

As previously mentioned, the AFP robot 18 executes a program that dictates the robot motions along with the operation of other components such as the heater, cutters, material feeders, etc. During the layup pass 60, the AFP robot 18 deposits the thermoplastic material in a direction corresponding to the desired fiber direction of a particular ply. However, the consolidation passes 62 are not dictated by fiber direction and, thus, are not limited to move solely in the fiber direction like the layup passes 60. Therefore, the program for consolidation passes 62 may be different from the program used for the layup passes 60. The program for consolidation passes 62 may move in any direction and speed that is suitable for consolidation. For instance, the AFP robot 18 may move cross-ply (transverse to the fiber direction) during the consolidation pass 62. The consolidation pass 62 may be programmed such that the AFP head 16 moves from the center of the thermoplastic composite article to the edges, consolidating the thermoplastic composite material in a radial or fan-like pattern. The layup pass 60 may be a continuous movement which is ideal for depositing the thermoplastic composite material. The consolidation pass 62 may be a stepwise, intermittent application of force, especially when a compaction tool other than a roller is utilized.

In an embodiment, the AFP robot 18 may be programmed to run the layup pass 60 at a faster speed than the consolidation pass 62. Despite this, the in-situ consolidation process disclosed herein can lead to a reduction in overall cycle time to construct the thermoplastic composite article. Two factors contribute to this: First, the in-situ consolidation process disclosed herein allows for faster layup passes 60 than traditional in-situ consolidation methods. Second, consolidation passes 62 can be strategically interspersed throughout the layup process, occurring at various stages or ply stackups. By contrast, conventional in-situ consolidation processes apply consolidation efforts to each and every layer as it is being deposited.

The combination of secondary consolidation passes and mold heating above Tg can enable thorough consolidation of the thermoplastic composite material throughout the part's thickness. Under the right process conditions, the inventors believe this process can achieve levels of consolidation comparable to autoclave processing, but without the need for separate post-processing steps. The ability to produce fully consolidated parts out-of-autoclave directly from the AFP process represents a key advantage of the disclosed system and method.

The choice of thermoplastic composite material influences the success of in-situ consolidation processes. A suitable material for the ICASH process is Solvay APC PEKK-FC/AS4D. The tape morphology of APC lends to better processing with the ICASH process and results in higher interlaminar strength. The inventors believe that the irregular fiber and resin distribution within the tape, whether by increased surface area or resin rich pockets, increases the fusion of the thermoplastic material at the interface between plies.

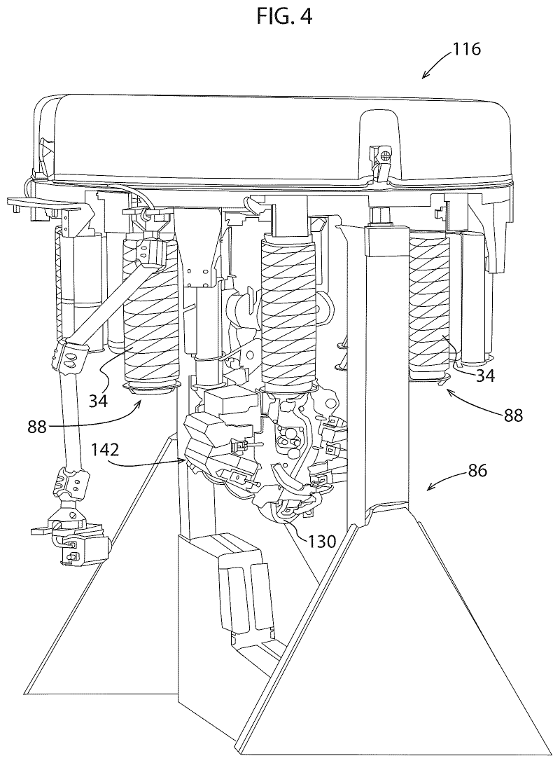

Referring to FIG. 4, an exemplary embodiment of a removable AFP head 116 is shown on a stand 86. In this perspective view, the AFP head 116 is removed from the AFP robot. A mechanism for automatically coupling and decoupling an AFP head 116 to an AFP robot comprises a quick-change interface system (tool changer). An ICASH system can be programed to automatically exchange the AFP head 116 for another tool (e.g., a consolidation head) during the layup and consolidation of a thermoplastic composite article. The AFP head 116 in FIG. 4 is used to deposit thermoplastic composite material 34 while applying a first compaction force and first heat during a layup pass 60. With this particular configuration, the AFP head 116 includes multiple spools 88 of thermoplastic composite material 34. The spools 88 are mounted on rotating spindles, allowing for smooth material feed during the layup processes. The on-head spool configuration may incorporate individual tension control mechanisms for each spool, ensuring suitable material feed rates and tension across varying layup geometries. The thermoplastic composite material 34 on the spools is fed to the heating area, where it is deposited onto the mold 50 and compacted with the compaction tool.

In this embodiment, the thermoplastic composite material is compacted using a compaction roller 130 as the first compaction tool 40. The AFP head 16 employs an interchangeable compaction roller 130, which can be modified in both dimension and composition to suit various applications. Depending on the number of strips of thermoplastic composite material the AFP head 16 is configured to place, roller sizes may vary, for many applications roller sizes of 5-10 cm are used. The heating of thermoplastic composite materials can be achieved through any appropriate heater capable of outputting enough energy to melt or significantly soften the material. In this example, the first heater 142 is a laser heater.

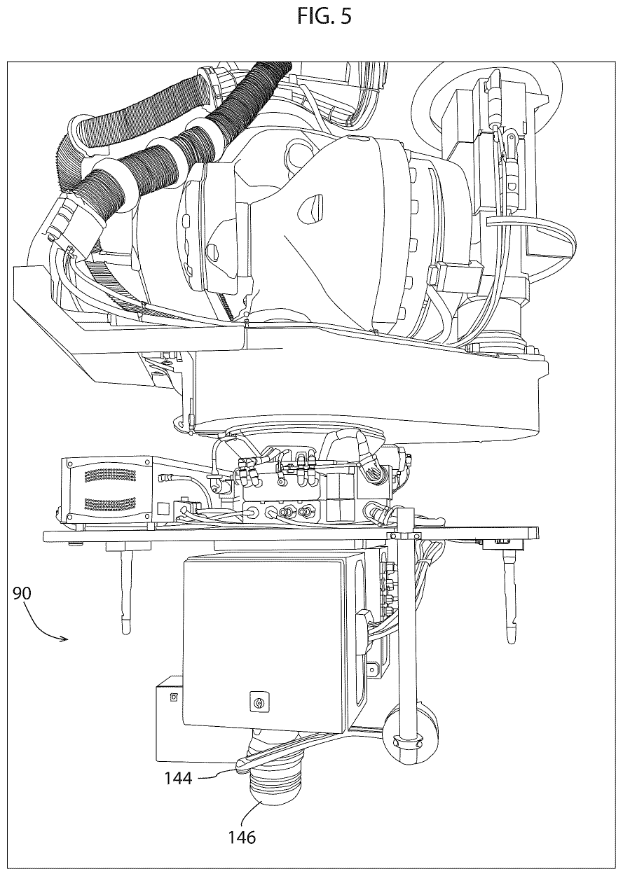

Now turning to FIG. 5, a secondary heating and compaction head is shown mounted on a robot 18. The secondary heating and compaction head is generally referred to as a consolidation AFP head 90. The consolidation AFP head 90 is equipped with the same quick-change interface system as the layup AFP head 16. The consolidation AFP head 90 includes a second compaction tool 146 and a second heater 144 and may be used to complete consolidation passes 62 on the thermoplastic composite article. In this embodiment, the compaction tool 146 comprises a flexible shoe made of a conformable elastomeric material such as high temperature silicone rubber or other suitable flexible polymers. The flexible shoe is configured to deform and conform to surface variations and contours of the thermoplastic composite laminate, ensuring uniform contact pressure distribution across curved surfaces. The second heater 144 is an infrared heater positioned adjacent to or integrated with the flexible shoe such that the infrared radiation is directed toward the area of the thermoplastic composite plies just below the shoe. Once the material has been heated to a temperature close to melt temperature, the compaction tool applies pressure to the material and maintains pressure until the material has cooled and solidified. The secondary heating and compaction head may include sensors for monitoring the temperature of the thermoplastic composite laminate to ensure consolidation and cooling temperatures are reached during the consolidation passes.

Other types of consolidation heads are contemplated with different types of compaction tools and heaters, for example, a roller may be used in combination with an induction heater to continuously heat and compress the thermoplastic composite material. The induction heater comprises one or more induction coils configured to generate alternating magnetic fields that induce eddy currents within the composite, thereby generating heat volumetrically throughout the thickness of the thermoplastic composite laminate. The induction coils may be designed as pancake coils or other geometries optimized for specific consolidation application. The induction heating system may include flux concentrators to focus the magnetic field within the consolidation zone and minimize the heating of surrounding areas. Power control systems may modulate the induction heating output to maintain precise temperature control during the consolidation process.

Because no new material is being deposited during the consolidation pass 62, it may be possible to direct heat into the thermoplastic composite article more effectively than has been possible using conventional in-situ consolidation techniques where consolidation efforts are conducted simultaneously with the layup pass. As previously mentioned, during the layup pass 60, the incoming strips of thermoplastic composite material are heated along with the previously deposited material to cause the materials to fuse during deposition. In the case of the layup passes 60, the AFP heater configuration and program is not designed for through thickness heating of the previously laid plies. Whereas, the consolidation AFP head may be optimized for through thickness heating of the previously laid thermoplastic composite plies to better consolidate the thermoplastic composite material. The enhanced consolidation process of the consolidation AFP head is believed to produce more complete matrix flow, void elimination, and inter-ply fusing throughout the full thickness of the composite structure.

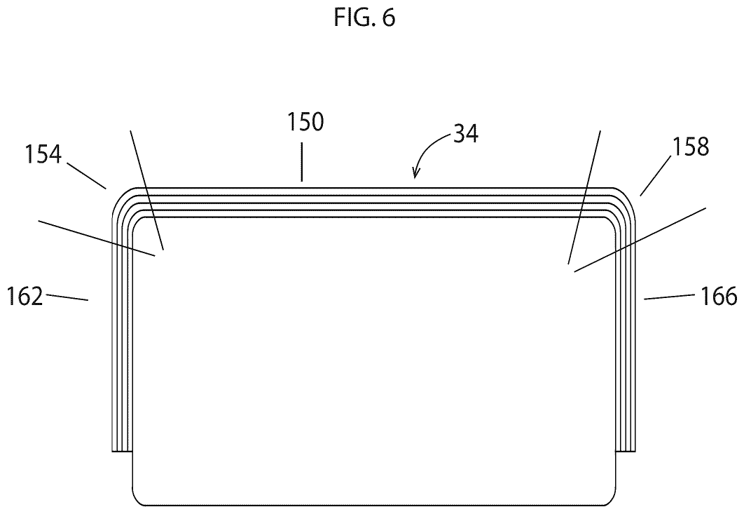

Referring to FIG. 6, a thermoplastic composite article with multiple plies of thermoplastic composite material is shown at reference number 34. To illustrate the concept of tailored programing to optimize consolidation through multiple consolidation passes, the thermoplastic composite article has been divided into 5 sections, a first flange 162, a second flange 166, a web 150, a first radius 154, and second radius 158. Decoupling consolidation passes 62 from the layup passes 60 makes it possible to conduct additional consolidation (e.g., a greater number of consolidation passes) along selected areas of the thermoplastic composite article that may be more prone to defects. For example, additional consolidation passes may be completed in areas such as the radius areas 154, 158 shown in FIG. 6. The program for performing the secondary compaction and heating may instruct the AFP robot 18 to conduct two consolidation passes 62 along the flanges and the web and four consolidation passes for additional along the corner regions 154, 158.

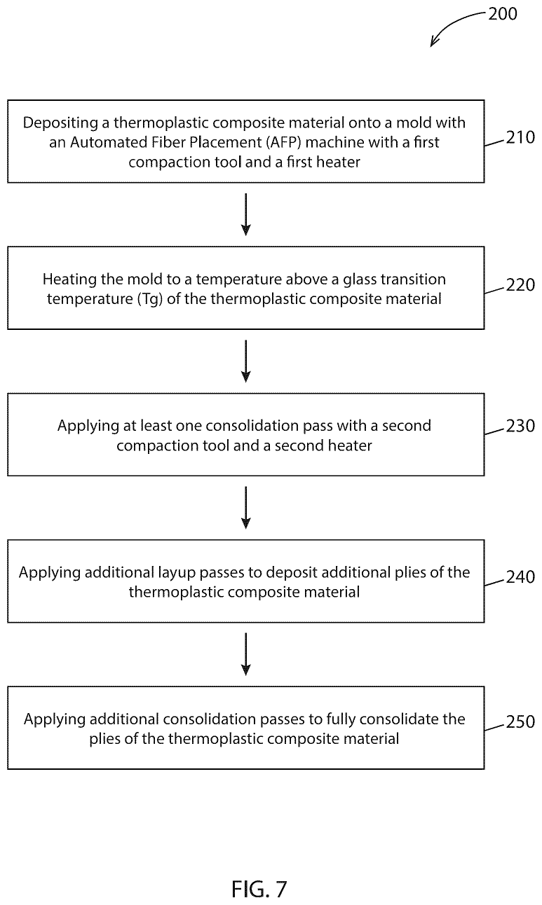

Referring to FIG. 7, an example method of in-situ consolidation and secondary heating of AFP thermoplastic composites is generally indicated at reference number 200. Thermoplastic composite material is deposited with an Automated Fiber Placement (AFP) machine onto a mold, as depicted in block 210. The first compaction tool applies a first compaction force while the first heater heats the thermoplastic composite material being deposited upon the mold in at least one layup pass. The AFP machine may perform multiple layup passes to construct a full ply of thermoplastic composite material onto the mold. The AFP machine may deposit more plies of thermoplastic composite material to build up the thermoplastic composite article.

At step 220, the mold is heated to a temperature above the glass transition temperature (Tg) of the thermoplastic composite material. At step 230, at least one consolidation pass with a second compaction tool and a second heater is applied to the deposited material. In some embodiments, the thermoplastic composite material on the mold may be covered by a protective film, which may be a plastic film (e.g., polyimide film) such as a vacuum bag. The plastic film is suitably a polymer with sufficient heat resistance to withstand the high processing temperatures used to consolidate thermoplastic composite materials. In an embodiment the plastic film (vacuum bag) is sealed against the mold and a pressure differential, i.e., vacuum, is applied to remove the air between the thermoplastic composite article and the film. Then, at least one consolidation pass with a second compaction tool and a second heater is applied to the deposited material. If a protective film is present covering the deposited material, the compaction tool contacts the protective film instead of the deposited material while applying compaction force. Alternatively, the consolidation passes may be performed with the second compaction tool in direct contact with the deposited thermoplastic composite material.

During the consolidation passes (step 230), the mold is heated to a temperature above a glass transition temperature (Tg) of the thermoplastic composite material. Optionally, the mold may also be heated to a temperature above the glass transition (Tg) of the thermoplastic composite material during the layup passes (step 210). It should be noted that the use of a vacuum bag or plastic film is not required to perform a consolidation pass, although it may be preferable to use a film to insulate and protect the material during consolidation passes. Using a film during consolidation passes may also enhance the surface finish of the thermoplastic composite article. A protective film or vacuum bag film suitable for use under these conditions is Kapton®, a polyimide film.

At step 240, additional layup passes may be applied to deposit additional plies of thermoplastic composite material. At step 250, additional consolidation passes may be applied to fully consolidate the plies of thermoplastic composite material. Multiple consolidation passes may be applied consecutively to fully consolidate and/or anneal the previously laid plies of thermoplastic composite material. However, while individual layup passes construct each ply of the composite article, consolidation passes can occur less frequently, such as but not limited to, every other ply, every 4 plies, every 8 plies, etc. The protective film and/or vacuum bag is removed before additional layup passes are performed. Additional layup passes are completed to deposit more plies. The AFP program may alternate between layup passes (steps 210, 240) and consolidation passes (steps 230, 250) as many times as desired to finish the composite article. By alternating between layup passes and consolidation passes, and maintaining the mold temperature above Tg during consolidation, the method produces a fully consolidated thermoplastic composite article without the need for autoclave processing. This out-of-autoclave consolidation results in a finished part with properties comparable to those achieved through traditional autoclave methods.

Those skilled in the art will now appreciate that the disclosed system and method for in-situ consolidation and secondary heating of AFP thermoplastic composites may offer advances in the field of thermoplastic composite manufacturing. By decoupling the layup and consolidation processes, the system allows for tailoring each stage for its objectives, potentially leading to improved composite quality and reduced processing times. The use of a heated mold maintained above the glass transition temperature during consolidation passes may enhance polymer chain mobility and interlaminar fusion. The ability to tailor consolidation parameters for specific regions of the composite structure, such as applying additional passes to radius areas, may address common defect-prone zones in complex geometries. Furthermore, the flexibility to use different compaction tools and heating methods for layup and consolidation passes may enable more efficient material deposition and more thorough through-thickness heating. One or more of the innovations disclosed herein may result in higher quality thermoplastic composite parts with improved mechanical properties, reduced void content, and enhanced surface finish, while potentially reducing overall manufacturing time and energy consumption compared to traditional autoclave-based processes. The disclosed system and method for in-situ consolidation and secondary heating of AFP thermoplastic composites enable the production of fully consolidated parts out-of-autoclave. This capability offers significant advantages over conventional manufacturing processes, potentially reducing energy consumption, processing time, and production costs while maintaining high part quality and performance.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A method of constructing an Automated Fiber Placement (AFP) article, the method comprising:
depositing a thermoplastic composite material onto a mold with an Automated Fiber Placement (AFP) machine while applying a layup pass with a first compaction tool and a first heater; and
applying a consolidation pass with a second compaction tool and a second heater to consolidate the thermoplastic composite material after the thermoplastic composite material has been deposited; and
heating the mold to a temperature above a glass transition temperature (Tg) of the thermoplastic composite material during the application of the consolidation pass.

2. The method of claim 1, further comprising covering the thermoplastic composite material with a film before applying the consolidation pass and applying the consolidation pass with the film in between the second compaction tool and the thermoplastic composite material.

3. The method of claim 2, wherein the film is a polyimide film.

4. The method of claim 2, wherein the film is a vacuum bag.

5. The method of claim 1, further comprising heating the mold to a temperature above the glass transition temperature (Tg) of the thermoplastic composite material during the layup pass.

6. The method of claim 1, wherein the first compaction tool is the same as the second compaction tool, the compaction tool being a roller.

7. The method of claim 6, wherein the roller is a silicone roller.

8. The method of claim 7, wherein the silicone roller is a 60 Shore A silicone roller.

9. The method of claim 1, wherein the first heater is the same as the second heater.

10. The method of claim 9, wherein the first and second compaction heater is a laser.

11. The method of claim 1, wherein the first compaction heater is different than the second heater.

12. The method of claim 11, wherein the first compaction heater is a laser and the second heater is an induction heater.

13. The method of claim 1, wherein the first compaction tool is different than the second compaction tool.

14. The method of claim 13, wherein the first compaction tool is a silicone roller and second compaction tool is a metallic roller.

15. The method of claim 1, further comprising applying a compaction force with the second compaction tool, the compaction force being between 200N and 1500N.

16. The method of claim 1, further comprising heating the mold to a temperature at least 40 degrees Fahrenheit greater than the Tg of the thermoplastic composite material.

17. The method of claim 1, further comprising moving the first compaction tool at a first speed and moving the second compaction tool at a second speed, wherein the first speed is greater than the second speed.

18. The method of claim 1, wherein the AFP article is a finished part fully consolidated out-of-autoclave.

19. An automated fiber placement (AFP) system for manufacturing thermoplastic composite articles, the system comprising:
an AFP head configured to deposit thermoplastic composite material onto a mold;
a first compaction tool and a first heater configured to apply a layup pass during deposition of the thermoplastic composite material;
a second compaction tool and a second heater configured to apply a consolidation pass to the deposited thermoplastic composite material after deposition;
a heated mold configured to be heated above a glass transition temperature of the thermoplastic composite material during the consolidation passes; and
a controller configured to coordinate operation of the first and second compaction tools, and the first and second heaters.

20. A method of constructing an Automated Fiber Placement (AFP) article, the method comprising:
performing a plurality of layup passes using an AFP head to deposit thermoplastic composite plies onto a mold with a first heater and a first compaction tool;
performing at least one consolidation pass using a consolidation head different from the AFP head, wherein the consolidation pass comprises heating the deposited thermoplastic composite plies with a second heater and a second compaction tool; and
alternating between layup passes and consolidation passes to construct a fully consolidated thermoplastic composite article.
